(19) United States
(12) Patent Application Publication
(10) Pub. No.: US 2026/0011020 A1
(43) Pub. Date: Jan. 8, 2026

(54) OBJECT VELOCITY DETERMINATION

(71) Applicant: QUALCOMM Incorporated, San Diego, CA (US)

(72) Inventors: Madhumitha Sakthi, San Diego, CA (US); Varun Ravi Kumar, San Diego, CA (US); Louis Joseph Kerofsky, San Diego, CA (US); Senthil Kumar Yogamani, San Diego, CA (US)

(21) Appl. No.: 18/762,537

(22) Filed: Jul. 2, 2024

(51) Int. Cl. G06T 7/246; G01S 13/58; G01S 13/86; G01S 13/931

(52) U.S. Cl. CPC G06T 7/248; G01S 13/58; G01S 13/867; G01S 13/931; G06T 2200/04; G06T 2207/10016; G06T 2207/30261

(57) ABSTRACT

An apparatus is configured to generate first image feature vectors for a first frame of the video data, generate second image feature vectors for a second frame of the video data, determine, from first image feature vectors and the second image feature vectors, respective initial 3D velocities of points of the first frame of the video data, generate ranging feature vectors from the ranging sensor information, the ranging sensor information including respective radial velocities of one or more objects relative to a ranging sensor, and respective ranges of the one or more objects relative to the ranging sensor, associate feature vectors from the first image feature vectors and the ranging feature vectors that are from common objects of the one or more objects to generate associated feature vectors, and determine respective output 3D object velocities for the one or more objects based on the associated feature vectors.

### TECHNICAL FIELD

This disclosure relates to object detection and velocity estimation.

### BACKGROUND

Computer vision applications, including applications in automotives, make use of the detection and analysis of three-dimensional (3D) objects and their velocities. 3D object detection may include the identification and localization of objects in 3D space using sensors like cameras, LiDAR, and radar. Algorithms process this data to recognize and position objects accurately, enhancing real-time situational awareness. Velocity determination may include the calculation of the speed and direction of moving objects by analyzing spatial data over time. Velocity determination is useful for predicting object trajectories, which may be helpful for making navigation decisions in dynamic environments, such as path finding, collision avoidance, adaptive cruise control, parking assistance, and others.

### SUMMARY

In general, this disclosure describes techniques determining the velocity (e.g., a 3D velocity) of a dynamic object using both images captured by a camera (e.g., frames of a video stream) as well as data from a ranging sensor (e.g., a radar scan). The techniques of this disclosure include a multi-sensor (e.g., camera and radar) fusion strategy for dynamic object velocity estimation which may overcome the limitations of detecting object velocity using a camera or ranging sensor alone by leveraging the complementary strengths of two sensors.

In one example, the velocity determination techniques described herein include a two-stage association process that combines sparse radar returns with optical flow features in video data, enabling more accurate velocity estimation under diverse operating conditions. The techniques of the disclosure may further include performing k-means clustering on optical flow features, where the number of clusters is set to the number of radar detections. In this way, the techniques of the disclosure may achieve more accurate object-level segmentation, and may avoid over/under-segmentation. In addition, the techniques of this disclosure may utilize deformable cross-attention between radar queries and image keys/values to correct potential errors in optical flow velocity estimation from camera features alone. The techniques of this disclosure may further incorporate temporal consistency checking over multiple frames, and reinitializing a moving average of velocity estimations when deviations from the moving average exceed a threshold, thus enhancing robustness.

In one example, this disclosure describes an apparatus configured to determine a velocity of one or more objects, the apparatus comprising a memory configured to store video data and ranging sensor information, and processing circuitry connected to the memory. The processing circuitry configured to generate first image feature vectors for a first frame of the video data, generate second image feature vectors for a second frame of the video data, determine, from first image feature vectors and the second image feature vectors, respective initial 3D velocities of points of the first frame of the video data, generate ranging feature vectors from the ranging sensor information, the ranging sensor information including respective radial velocities of one or more objects relative to a ranging sensor, and respective ranges of the one or more objects relative to the ranging sensor, associate feature vectors from the first image feature vectors and the ranging feature vectors that are from common objects of the one or more objects to generate associated feature vectors, and determine respective output 3D object velocities for the one or more objects based on the associated feature vectors.

In another example, this disclosure describes a method for determining a velocity of one or more objects, the method comprising generating first image feature vectors for a first frame of the video data, generating second image feature vectors for a second frame of the video data, determining, from first image feature vectors and the second image feature vectors, respective initial 3D velocities of points of the first frame of the video data, generating ranging feature vectors from the ranging sensor information, the ranging sensor information including respective radial velocities of one or more objects relative to a ranging sensor, and respective ranges of the one or more objects relative to the ranging sensor, associating feature vectors from the first image feature vectors and the ranging feature vectors that are from common objects of the one or more objects to generate associated feature vectors, and determining respective output 3D object velocities for the one or more objects based on the associated feature vectors.

In another example, this disclosure describes a non-transitory computer-readable storage medium storing instructions that, when executed, cause one or more processors to generate first image feature vectors for a first frame of the video data, generate second image feature vectors for a second frame of the video data, determine, from first image feature vectors and the second image feature vectors, respective initial 3D velocities of points of the first frame of the video data, generate ranging feature vectors from the ranging sensor information, the ranging sensor information including respective radial velocities of one or more objects relative to a ranging sensor, and respective ranges of the one or more objects relative to the ranging sensor, associate feature vectors from the first image feature vectors and the ranging feature vectors that are from common objects of the one or more objects to generate associated feature vectors, and determine respective output 3D object velocities for the one or more objects based on the associated feature vectors.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a diagram of an example vehicle in accordance with the techniques of this disclosure for object velocity determination.

FIG. 2 is a block diagram illustrating an example system that may perform the techniques of this disclosure for object velocity determination.

FIG. 3 is a block diagram illustrating an example of object velocity determination in more detail.

FIG. 4 is a conceptual diagram showing frames for a temporal consistency check.

FIG. 5 is a flowchart illustrating an example method for object velocity determination in accordance with the techniques of this disclosure.

### DETAILED DESCRIPTION

Estimating dynamic object velocities accurately and robustly across sensor modalities is beneficial for safe path planning and decision making in autonomous driving systems and advanced driver assistance systems (ADAS). While optical flow from camera sensors provides dense motion fields, optical flow techniques can fail under conditions of high dynamic motion or adverse weather. In addition, optical flow techniques alone may become unreliable where objects in a scene become occluded from frame to frame, or because of drastic scene or lighting changes. Doppler radar or other ranging sensors may provide sparse but reliable range, azimuth and radial velocity measurements. However, radial velocity alone does not fully capture the true motion of objects in the scene in many circumstances.

This disclosure describes multi-sensor fusion techniques that leverage the complementary strengths of camera and ranging sensors (e.g., radar) while addressing their individual limitations. The multi-sensor fusion techniques of this disclosure may provide for more accurate dynamic object velocity estimates under a variety of operating conditions. One key challenge with using a ranging sensor like radar, is that the returns of a ranging sensor may be sparse in both spatial and temporal terms, making it difficult to associate measurements with tracked objects across frames. Additionally, small errors in velocity estimation can accumulate over time if not addressed, thus degrading trajectory predictions. Therefore, given video-based flow estimation and sparse ranging sensor returns, the techniques of this disclosure may correct the erroneous dynamic object velocity.

In one example, the velocity determination techniques described herein include a two-stage association process that combines sparse radar returns with optical flow features in video data, enabling more accurate velocity estimation under diverse operating conditions. The techniques of the disclosure may further include performing k-means clustering on optical flow features, where the number of clusters is set to the number of radar detections. In this way, the techniques of the disclosure may achieve more accurate object-level segmentation, and may avoid over/under-segmentation. In addition, the techniques of this disclosure may utilize deformable cross-attention between radar queries and image keys/values to correct errors in optical flow velocity estimation from camera features alone. The techniques of this disclosure may further incorporate temporal consistency checking over multiple frames, reinitializing estimation when deviations from the moving average exceed a threshold, thus enhancing robustness.

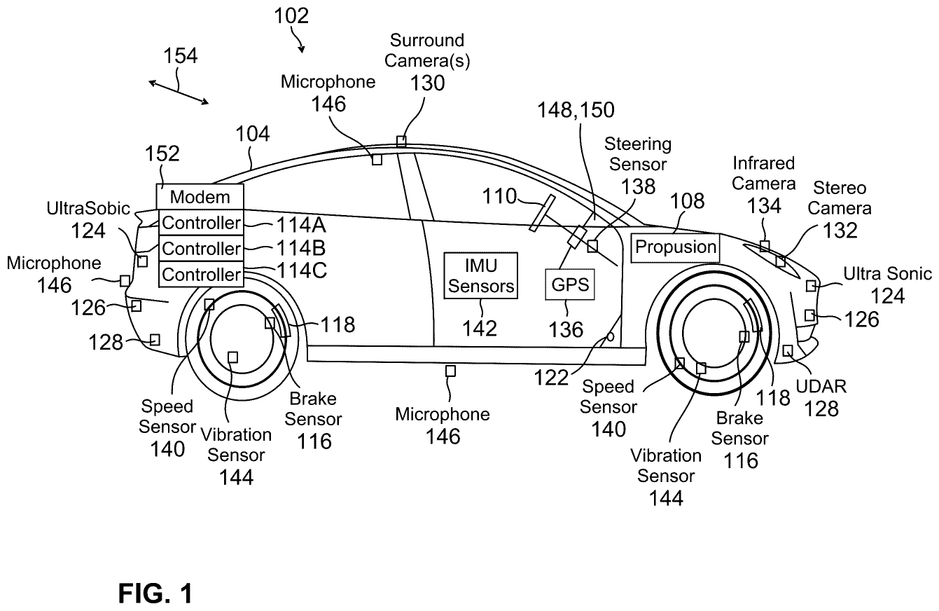

FIG. 1 shows an example vehicle 102. Vehicle 102 in the example shown may comprise a passenger vehicle such as a car or truck that can accommodate a human driver and/or human passengers. In one example, vehicle 102 may comprise an autonomous vehicle, semi-autonomous vehicle and/or an ADAS. Vehicle 102 may include a vehicle body 104 suspended on a chassis, in this example comprised of four wheels and associated axles. A propulsion system 108 such as an internal combustion engine, hybrid electric power plant, or even all-electric engine may be connected to drive some or all of the wheels via a drive train, which may include a transmission (not shown). A steering wheel 110 may be used to steer some or all of the wheels to direct vehicle 102 along a desired path when the propulsion system 108 is operating and engaged to propel the vehicle 102. Steering wheel 110 or the like may be optional for Level 5 implementations. One or more controllers 114A-114C (a controller 114) may provide autonomous capabilities in response to signals continuously provided in real-time from an array of sensors, as described more fully below.

Each controller 114 may be one or more onboard computers that may be configured to perform deep learning and/or artificial intelligence functionality and output autonomous operation commands to self-drive vehicle 102 and/or assist the human vehicle driver in driving. Each vehicle may have any number of distinct controllers for functional safety and additional features. For example, controller 114A may serve as the primary computer for autonomous driving functions, controller 114B may serve as a secondary computer for functional safety functions, controller 114C may provide artificial intelligence functionality for in-camera sensors, and controller 114D (not shown) may provide infotainment functionality and provide additional redundancy for emergency situations.

Controller 114 may send command signals to operate vehicle brakes 116 via one or more braking actuators 118, operate steering mechanism via a steering actuator, and operate propulsion system 108 which also receives an accelerator/throttle actuation signal 122. Actuation may be performed by methods known to persons of ordinary skill in the art, with signals typically sent via the Controller Area Network data interface (“CAN bus”)—a network inside modern cars used to control brakes, acceleration, steering, windshield wipers, and the like. The CAN bus may be configured to have dozens of nodes, each with its own unique identifier (CAN ID). The bus may be read to find steering wheel angle, ground speed, engine RPM, button positions, and other vehicle status indicators. The functional safety level for a CAN bus interface is typically Automotive Safety Integrity Level (ASIL) B. Other protocols may be used for communicating within a vehicle, including FlexRay and Ethernet.

In one example, an actuation controller may include dedicated hardware and software, allowing control of throttle, brake, steering, and shifting. The hardware may provide a bridge between the vehicle's CAN bus and the controller 114, forwarding vehicle data to controller 114 including the turn signal, wheel speed, acceleration, pitch, roll, yaw, Global Positioning System (“GPS”) data, tire pressure, fuel level, sonar, brake torque, and others. Similar actuation controllers may be configured for any other make and type of vehicle, including special-purpose patrol and security cars, robo-taxis, long-haul trucks including tractor-trailer configurations, tiller trucks, agricultural vehicles, industrial vehicles, and buses.

Controller 114 may provide autonomous driving outputs in response to an array of sensor inputs including, for example: one or more ultrasonic sensors 124, one or more RADAR sensors 126, one or more LiDAR sensors 128, one or more surround cameras 130 (typically such cameras are located at various places on vehicle body 104 to image areas all around the vehicle body), one or more stereo cameras 132 (in one example, at least one such stereo camera may face forward to provide object recognition in the vehicle path), one or more infrared cameras 134, GPS unit 136 that provides location coordinates, a steering sensor 138 that detects the steering angle, speed sensors 140 (one for each of the wheels), an inertial sensor or inertial measurement unit (“IMU”) 142 that monitors movement of vehicle body 104 (this sensor can be for example an accelerometer(s) and/or a gyro-sensor(s) and/or a magnetic compass(es)), tire vibration sensors 144, and microphones 146 placed around and inside the vehicle. Other sensors may be used, as is known to persons of ordinary skill in the art.

Controller 114 may also receive inputs from an instrument cluster 148 and may provide human-perceptible outputs to a human operator via human-machine interface (“HMI”) display(s) 150, an audible annunciator, a loudspeaker and/or other means. In addition to traditional information such as velocity, time, and other well-known information, HMI display 150 may provide the vehicle occupants with information regarding maps and vehicle's location, the location of other vehicles (including an occupancy grid) and even the Controller's identification of objects and status. For example, HMI display 150 may alert the passenger when the controller 114 has identified the presence of a stop sign, caution sign, or changing traffic light and is taking appropriate action, giving the vehicle occupants peace of mind that the controller 114 is functioning as intended. In one example, instrument cluster 148 may include a separate controller/processor configured to perform deep learning and artificial intelligence functionality.

Vehicle 102 may collect data that is preferably used to help train and refine the neural networks used for autonomous driving. The vehicle 102 may include modem 152, preferably a system-on-a-chip that provides modulation and demodulation functionality and allows the controller 114 to communicate over the wireless network 154. Modem 152 may include an RF front-end for up-conversion from baseband to RF, and down-conversion from RF to baseband, as is known in the art. Frequency conversion may be achieved either through known direct-conversion processes (direct from baseband to RF and vice-versa) or through super-heterodyne processes, as is known in the art. Alternatively, such RF front-end functionality may be provided by a separate chip. Modem 152 preferably includes wireless functionality substantially compliant with one or more wireless protocols such as, without limitation: LTE, WCDMA, UMTS, GSM, CDMA2000, or other known and widely used wireless protocols.

It should be noted that, compared to sonar and RADAR sensors 126, cameras 130-134 may generate a richer set of features at a fraction of the cost. Thus, vehicle 102 may include a plurality of cameras 130-134, capturing images around the entire periphery of the vehicle 102. Camera type and lens selection depends on the nature and type of function. The vehicle 102 may have a mix of camera types and lenses to provide complete coverage around the vehicle 102; in general, narrow lenses do not have a wide field of view but can see farther. All camera locations on the vehicle 102 may support interfaces such as Gigabit Multimedia Serial link (GMSL) and Gigabit Ethernet.

In one example, controller 114 may be configured to determine a respective 3D object velocity for one or more objects near vehicle 2 based on both video data received from one or more of cameras 130-134 (e.g., monocular video) as well as ranging sensor information received from a ranging sensor, such as ultrasonic sensors 124, RADAR sensors 126, LiDAR sensors 128, or any other ranging sensor capable of producing returns indicative of a predicted range/position of an object as well as the radial velocity of the object.

In one specific example, as will be explained in more detail below controller 114 may be configured to generate first image feature vectors for a first frame of video data, and generate second image feature vectors for a second frame of the video data. Controller 114 may be further configured to determine, from first image feature vectors and the second image feature vectors, respective initial 3D velocities of points of the first frame of the video data. Controller 114 may further generate ranging feature vectors from the ranging sensor information, the ranging sensor information including a number of one or more objects, respective radial velocities of the one or more objects relative to a ranging sensor, and respective ranges of the one or more objects relative to the ranging sensor. In some examples, the ranging sensor information may not directly include the number of one or more objects, but may include respective radial velocities of one or more objects and/or respective ranges of one or more objects from which controller 114 may derive the number of objects. Controller 114 may then associate feature vectors from the first image feature vectors and the ranging feature vectors that are from common objects of the one or more objects to generate associated feature vectors, and determine respective output 3D object velocities for the one or more objects based on the associated feature vectors.

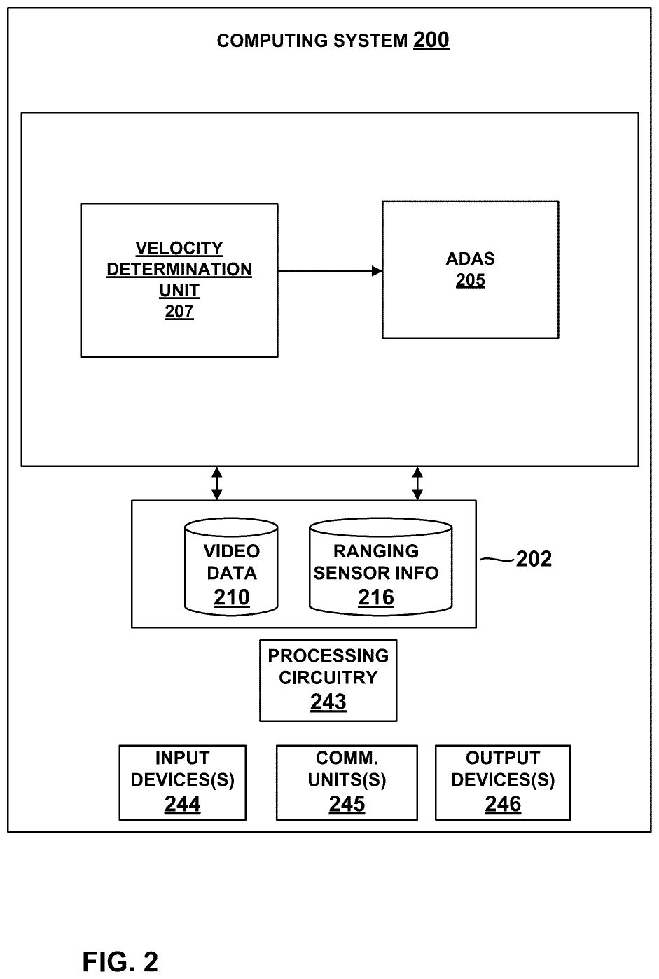

FIG. 2 is a block diagram illustrating an example computing system 200. As shown, computing system 200 comprises processing circuitry 243 and memory 202 for executing a velocity determination unit 207 and ADAS 205, which may represent an example instance of any controller 114 described in this disclosure, such as controller 114 of FIG. 1. The example of FIG. 2 shows velocity determination unit 207 and ADAS 205 as being separate. In other examples, velocity determination unit 207 may be a sub-unit of ADAS 205.

Computing system 200 also be implemented as any suitable external computing system accessible by controller 114, such as one or more server computers, workstations, laptops, mainframes, appliances, cloud computing systems, High-Performance Computing (HPC) systems (e.g., supercomputing) and/or other computing systems that may be capable of performing operations and/or functions described in accordance with one or more aspects of the present disclosure. In some examples, computing system 200 may represent a cloud computing system, server farm, and/or server cluster (or portion thereof) that provides services to client devices and other devices or systems. In other examples, computing system 200 may represent or be implemented through one or more virtualized compute instances (e.g., virtual machines, containers, etc.) of a data center, cloud computing system, server farm, and/or server cluster.

The techniques described in this disclosure for object velocity determination may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

In another example, computing system 200 comprises any suitable computing system having one or more computing devices, such as desktop computers, laptop computers, gaming consoles, smart televisions, handheld devices, tablets, mobile telephones, smartphones, etc. In some examples, at least a portion of computing system 200 is distributed across a cloud computing system, a data center, or across a network, such as the Internet, another public or private communications network, for instance, broadband, cellular, Wi-Fi, ZigBee, Bluetooth® (or other personal area network—PAN), Near-Field Communication (NFC), ultrawideband, satellite, enterprise, service provider and/or other types of communication networks, for transmitting data between computing systems, servers, and computing devices.

Memory 202 may comprise one or more storage devices. One or more components of computing system 200 (e.g., processing circuitry 243, memory 202, etc.) may be interconnected to enable inter-component communications (physically, communicatively, and/or operatively). In some examples, such connectivity may be provided by a system bus, a network connection, an inter-process communication data structure, local area network, wide area network, or any other method for communicating data. Processing circuitry 243 of computing system 200 may implement functionality and/or execute instructions associated with computing system 200. Examples of processing circuitry 243 include microprocessors, application processors, display controllers, auxiliary processors, one or more sensor hubs, and any other hardware configured to function as a processor, a processing unit, or a processing device. Computing system 200 may use processing circuitry 243 to perform operations in accordance with one or more aspects of the present disclosure using software, hardware, firmware, or a mixture of hardware, software, and firmware residing in and/or executing at computing system 200. The one or more storage devices of memory 202 may be distributed among multiple devices.

Memory 202 may store information for processing during operation of computing system 200. In some examples, memory 202 comprises temporary memories, meaning that a primary purpose of the one or more storage devices of memory 202 is not long-term storage. Memory 202 may be configured for short-term storage of information as volatile memory and therefore not retain stored contents if deactivated. Examples of volatile memories include random access memories (RAM), dynamic random-access memories (DRAM), static random-access memories (SRAM), and other forms of volatile memories known in the art. Memory 202, in some examples, may also include one or more computer-readable storage media. Memory 202 may be configured to store larger amounts of information than volatile memory. Memory 202 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories. Memory 202 may store program instructions and/or data associated with one or more of the modules described in accordance with one or more aspects of this disclosure.

Processing circuitry 243 and memory 202 may provide an operating environment or platform for one or more modules or units (e.g., velocity determination unit 207 and/or ADAS 205), which may be implemented as software, but may in some examples include any combination of hardware, firmware, and software. Processing circuitry 243 may execute instructions and the one or more storage devices, e.g., memory 202, may store instructions and/or data of one or more modules. The combination of processing circuitry 243 and memory 202 may retrieve, store, and/or execute the instructions and/or data of one or more applications, modules, or software. The processing circuitry 243 and/or memory 202 may also be operably coupled to one or more other software and/or hardware components, including, but not limited to, one or more of the components illustrated in FIG. 2.

Processing circuitry 243 may execute velocity determination unit 207 and/or ADAS 205 using virtualization modules, such as a virtual machine or container executing on underlying hardware. One or more of such modules may execute as one or more services of an operating system or computing platform. Aspects of machine learning system 204 may execute as one or more executable programs at an application layer of a computing platform.

One or more input devices 244 of computing system 200 may generate, receive, or process input. Such input may include input from a video camera, ranging sensor (e.g., one or more of radar, sonar, LiDAR, etc.), keyboard, pointing device, voice responsive system, biometric detection/response system, button, mobile device, control pad, microphone, presence-sensitive screen, network, or any other type of device for detecting input from a human or machine.

One or more output devices 246 may generate, transmit, or process output. Examples of output are tactile, audio, visual, and/or video output. Output devices 246 may include a display, sound card, video graphics adapter card, speaker, presence-sensitive screen, one or more USB interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 include a network interface card (e.g., such as an Ethernet card), an optical transceiver, a radio frequency transceiver, a GPS receiver, or any other type of device that can send and/or receive information. Other examples of communication units 245 may include Bluetooth®, GPS, 3G, 4G, and Wi-Fi® radios found in mobile devices as well as Universal Serial Bus (USB) controllers and the like.

In the example of FIG. 2, computing system 200 may be configured to execute velocity determination unit 207. As will be described in more detail below, velocity determination unit 207 may be configured to determine the 3D velocity of objects in the vicinity of computing system 200 (e.g., near vehicle 2 of FIG. 1) using both video data 210 and ranging sensor information 216. Video data 210 may be frames of video data captured by any number of cameras 130-134 shown in FIG. 1. In one example of the disclosure, video data 210 is monocular video data captured by a monocular camera. The techniques of this disclosure will be described with reference to a single stream of video data 210 captured by a single camera. However, velocity determination unit 207 may be configured to determine 3D object velocities from any number of streams of video data 210. In addition, velocity determination unit 207 may be configured to process video data 210 that is a combination of multiple video streams. Ranging sensor information 216 may include returns from one or more ranging sensors that indicate the predicted range of one or more objects as well as radial velocities associated with each of the detected objects. In one example, ranging sensor information 216 may be Doppler radar returns from a radar sensor, such as RADAR sensors 126 of FIG. 1.

The techniques of this disclosure for determining dynamic 3D object velocities accurately and robustly across sensor modalities is beneficial for safe path planning and decision making in autonomous driving systems and advanced driver assistance systems, such as ADAS 205. While optical flow from camera sensors provides dense motion fields, optical flow techniques can fail under conditions of high dynamic motion or adverse weather. In addition, optical flow techniques alone may become unreliable where objects in a scene become occluded from frame to frame, or because of drastic scene or lighting changes. Doppler radar or other ranging sensors may provide sparse but reliable range, azimuth and radial velocity measurements. However, radial velocity alone does not fully capture the true motion of objects in the scene in many circumstances.

Radial velocity is the component of an object's velocity directed along the line of sight of an observer (e.g., a ranging sensor, such as radar). The radial velocity of an object is the rate at which the distance between the object and the sensor is changing. As such, the term radial velocity described herein is relative to the ranging sensor which captured the redial velocity. Likewise, any measured or predicted ranges in ranging sensor information is relative to the ranging sensor. In some examples, radial velocity may be measured using the Doppler effect, which causes the wavelength of radar return from the object to shift depending on its motion relative to the sensor. If the object is moving toward the sensor, the wavelengths are compressed (blueshifted); if the objects is moving away from the sensor, the wavelengths are stretched (redshifted).

Radial velocity and total 3D velocity are related but distinct concepts in the context of an object's motion. As mentioned above, radial velocity is the component of an object's velocity that is directed along the line of sight of an observer (e.g., sensor), and indicates how fast the object is moving towards or away from the sensor. As such, the radial velocity only indicates the motion along the sensor's line of sight and does not represent any perpendicular motion. The total 3D velocity of an object is the vector sum of all components of an object's velocity in three-dimensional space. The total 3D velocity of an object describes the object's overall speed and direction of motion. The total 3D velocity describes movement in all three spatial dimensions, which may involve combining radial velocity with tangential velocity components (e.g., those components perpendicular to the line of the sensor).

Velocity determination unit 207 may be configured to determine 3D object velocities for one or more objects using multi-sensor fusion techniques that leverage the complementary strengths of both camera and ranging sensors (e.g., radar) while addressing their individual limitations. The multi-sensor fusion techniques of this disclosure may provide for more accurate dynamic object velocity estimates under a variety of operating conditions. One key challenge with using a ranging sensor like radar, is that the returns of a ranging sensor may be sparse in both spatial and temporal terms, making it difficult to associate measurements with tracked objects across frames. Additionally, small errors in velocity estimation can accumulate over time if not addressed, thus degrading trajectory predictions. Therefore, given video-based flow estimation and sparse ranging sensor returns, the techniques of this disclosure may correct the erroneous dynamic object velocity.

In one example, velocity determination unit 207 may be configured to determine a 3D velocity of an object using a two-stage association process that combines sparse radar returns with scene flow or optical flow features in video data, enabling more accurate velocity estimation under diverse operating conditions. Velocity determination unit 207 may be further configured to perform k-means clustering on scene flow or optical flow features, where the number of clusters is set to the number of radar detections. In this way, velocity determination unit 207 may be configured to achieve more accurate object-level segmentation, and may avoid over/under-segmentation. In addition, velocity determination unit 207 may be configured to use a trainable deformable cross-attention process that uses radar features as queries and image features as keys and values to correct errors in 3D velocities determined from scene flow or flow velocity video features alone. Velocity determination unit 207 may be configured to may further incorporate temporal consistency checking over multiple frames, reinitializing estimation when deviations from the moving average exceed a threshold, thus enhancing robustness.

Therefore, the technique of this disclosure provide robustness against individual sensor uncertainty by using both ranging (e.g., radar) and camera/video features in determining the 3D velocity of objects. In addition, in one example where radar is used, the techniques of this disclosure may predict object velocity based on low-cost camera and radar sensor data instead of relying on additional sensor information, such as LiDAR.

In one general example of the disclosure, velocity determination unit 207 may be configured to generate first image feature vectors for a first frame of the video data, and generate second image feature vectors for a second frame of the video data (e.g., a frame of video data before or after the first frame of video data). Velocity determination unit 207 may be further configured to determine, from first image feature vectors and the second image feature vectors, respective initial 3D velocities of points of the first frame of the video data.

Velocity determination unit 207 may further generate ranging feature vectors from the ranging sensor information, the ranging sensor information including a number of one or more objects, respective radial velocities of the one or more objects relative to a ranging sensor, and respective ranges of the one or more objects relative to the ranging sensor, and associate feature vectors from the first image feature vectors and the ranging feature vectors that are from common objects of the one or more objects to generate associated feature vectors. Velocity determination unit 207 may then determine respective output 3D object velocities for the one or more objects based on the associated feature vectors. ADAS 205 may use the output 3D object velocities as inputs to perform one or more autonomous driving tasks. Such autonomous driving tasks may include one or more of object detection and tracking, object trajectory prediction, path planning and navigation, pedestrian and cyclist detection, lane changing, collision avoidance, automatic braking, and adaptive cruise control.

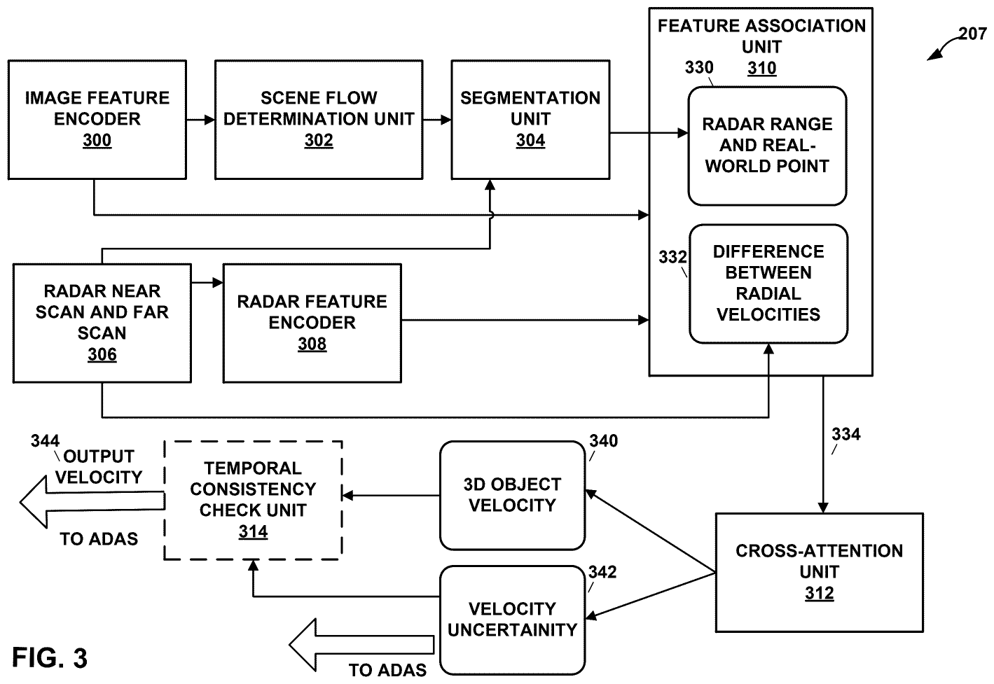

As will be explained in more detail below with reference to FIG. 3, the techniques of this disclosure include examples that leverage both radial velocity and predicted range from ranging sensor for associating sparse ranging sensor (e.g., radar) returns with image regions (e.g., regions of frames of video data). Using both range and radial velocity may improve association accuracy.

Examples of the disclosure may also use a deformable cross-attention process using ranging sensor feature vectors as queries and associated image feature vectors as keys/values to correct and/or improve 3D object values determined from a scene flow and/or optical flow process. Performing deformable cross-attention using both ranging sensor feature vectors and image feature vectors may improve the accuracy of determining 3D object velocities compared to other techniques, such as Kalman filtering or early/late fusion of independent sensor estimates.

Some techniques segment optical flow/scene flow outputs into a number of objects independently. In an example of this disclosure, velocity determination unit 207 may be configured to perform object-level segmentation (e.g., using k-means clustering) using the number of object detected by a ranging sensor in order to avoid over/under-segmentation issues.

The techniques of this disclosure may also include temporal consistency checking of object velocities tracked over multiple frames. The temporal consistency checking technique may also include the reinitialization of object velocity moving averages to avoid error propagation, which provides a more robust approach than single frame estimation or simple filtering.

In general, the multi-modal object velocity determination techniques of this disclosure allow for the tracking and 3D velocity determination of objects across frames, even when such objects become occluded or partially occluded in some sensor outputs (e.g., in a video frames). Furthermore, the use of multiple sensors to perform 3D object velocity determination is more robust to ranging sensor noise (e.g., radar noise) through the use of attention-based correction and temporal consistency checks.

FIG. 3 is a block diagram illustrating an example of object velocity determination unit 207 in more detail. In this example, velocity determination unit 207 received video data and radar scan information as input. However, it should be understood that any type of ranging sensor information that includes a predicted range and a radial velocity may be used in conjunction with the techniques of this disclosure.

Image encoder 300 may be configured to generate image feature vectors from video frames (e.g., video data 210). Image encoder 300 may generate image feature vectors for each frame of the video data. The example of FIG. 3 will be described with reference to two video frames, as the optical flow and/or scene flow determination techniques operate on at least two frames of video. A first frame of video data may be a currently captured frame and the second frame of video data may be a frame of video data captured before or after the first frame of video data.

Accordingly, image encoder 300 may be configured to generate first image feature vectors for a first frame of the video data, and second image feature vectors for a second frame of the video data. A feature vector is a numerical representation of an image or part of an image (e.g., pixel or block of pixels), capturing characteristics or features that are important for a specific task, such as classification, detection, recognition, velocity determination, etc. In general, a feature vector transforms visual information into a form that can be processed and analyzed by machine learning algorithms.

A feature vector is typically a one-dimensional array of numbers. The length of this array (i.e., the number of elements) corresponds to the number of features extracted from the image. Various techniques can be used to extract features from images, depending on the specific application. These techniques may include edge detection, color histograms, texture analysis, keypoint detection, or deep learning methods using convolutional neural networks (CNNs). Each element of the feature vector represents a specific attribute of the image, such as intensity, gradient, color information, or the presence of specific patterns. For example, in a deep learning context, the feature vector might be the output of a particular layer of a neural network, which encodes high-level features of the image.

Several types of neural networks can generate feature vectors from images. These networks are primarily used in tasks involving computer vision, such as image classification, object detection, and image retrieval. As some possible examples, image encoder 300 may be configured as a CNN, a residual network (ResNet), an inception network, a dense convolutional network (DenseNet), an autoencoder, a general adversarial network (GAN), a capsule network, a vision transformer, or another type of neural network.

In general, scene flow determination unit 302 receives the first image feature vectors and the second image feature vectors from image encoder 300 and determines, from first image feature vectors and the second image feature vectors, respective initial 3D velocities of points of the first frame of the video data. That is, scene flow determination unit 302 operates on feature vectors from two frames of video data to detect the movement of objects in the scene. Scene flow determination unit 302 may take into consideration the pose and movement of the camera from frame to frame to determine more accurate 3D motion, and thus 3D velocity, for objects in the scene.

In one example, scene flow determination unit 302 may be configured to perform optical flow estimation or scene flow estimation on the first image feature vectors and the second image feature vectors to determine the initial 3D velocities of the points of the first frame of the video data. The output of scene flow determination unit 302 is an (x,y,z) coordinate (e.g., a real world coordinate) of each point in the image (e.g., where each point has an associated feature vector) as well as a change in the (x,y,z) coordinate (e.g., a delta x, delta y, delta z) value for each point. A 3D object velocity for each point may be determined from the change in (x,y,z) values. In addition, a radial velocity for each point may be determined from the 3D object velocity.

Optical flow estimation and scene flow estimation are techniques used in computer vision, each focusing on different aspects of motion analysis in image sequences. Optical flow refers to the apparent motion of objects, surfaces, and edges within a visual scene, caused by the relative movement between an observer (e.g., a camera) and the scene. Scene flow extends optical flow techniques to 3D, capturing the motion of points in the 3D space of a scene.

In one example, scene flow determination unit 302 may perform the following process to determine 3D object velocities and real-world coordinates for points in a frame of video. However, any optical flow and/or scene flow techniques may be used in conjunction with the techniques of this disclosure. In one example, scene flow determination unit 302 uses feature vectors from two video frames to predict optical flow, depth, and scene flow simultaneously. Scene flow determination unit 302 uses the optical flow to generate an initial depth map through triangulation. Scene flow determination unit 302 may iteratively refine the depth and scene flow predictions using a recurrent neural network architecture, which incorporates both the correlation pyramid and context features from the images.

Scene flow determination unit 302 may be configured to process two video frame uses the known camera intrinsics and relative pose to generate the feature vectors. Scene flow determination unit 302 may generate 4D correlation volume from the pair-wise inner products of the feature vectors, forming the basis for estimating optical flow. Scene flow determination unit 302 uses this estimated optical flow to triangulate an initial depth map, considering the displacement between the corresponding pixels in the video frame pair.

To refine the depth and scene flow estimates, scene flow determination unit 302 may process the initial triangulated depth map through a depth context encoder and combined with context features. Scene flow determination unit 302 may then iteratively improve these estimates by querying the correlation pyramid and adjusting the predictions. This approach allows for the integration of optical flow predictions as initial estimates, enhancing the accuracy of the depth and scene flow outputs.

Scene flow determination unit 302 may use forward-backward consistency to handle occluded regions between frames. By comparing forward and backward predicted optical flows, scene flow determination unit 302 may determine inconsistent regions and filter them out during the self-supervised learning process.

Radar near scan and far scan unit 306 provide radar information (e.g., near scan and far scan lists) from a radar sensor. Radar sensors, widely used in various applications such as automotive systems, aviation, and maritime navigation, produce object lists based on the detection and ranging of objects in their environment. These object lists are typically categorized into two main types: near scan and far scan object lists. Each list serves a specific purpose based on the range and characteristics of detected objects.

The near scan object list comprises objects that are detected within a relatively short range from the radar sensor. This range is typically defined by the radar system's configuration and the application's requirements. The specific range for near scan objects varies depending on the radar's design and purpose. In automotive applications, near scan ranges might be up to 30 meters, focusing on detecting objects immediately around the vehicle for collision avoidance and maneuvering in tight spaces. Near scan modes often provide higher resolution and accuracy compared to far scan modes. This is because objects closer to the radar sensor can be detected with finer detail, allowing for more precise measurements of their position, speed, and other characteristics. The near scan object list typically includes detailed information about each detected object, such as an object id, range, range standard deviation, radial velocity, azimuth, azimuth angle, elevation angle, object existence probability, among other measurements.

The far scan object list includes objects detected at greater distances from the radar sensor. The far scan object lists list helps monitor and track objects that are farther away, providing situational awareness over a broader area. The range for far scan objects extends beyond the near scan range, often covering distances up to several hundred meters. In automotive radars, this can be up to 250 meters or more, depending on the radar's power and design. Far scan modes typically have lower resolution and accuracy compared to near scan modes. This is due to the increased distance, which can make it more challenging to detect and accurately measure the characteristics of objects. However, the radar still provides sufficient information for tracking and identifying distant objects. The far scan object list may include the same data as the near scan object list, but at a reduced granularity. Combining near scan and far scan object lists enables radar systems to provide comprehensive situational awareness. By integrating data from both lists, radar sensors can offer a multi-layered view of the environment, enhancing safety and performance in various applications.

Radar feature encoder 308 may generate ranging feature vectors from the ranging sensor information (e.g., the near and far scan object lists of radar near scan and far scan unit 306). In general, the ranging sensor information may include a number of one or more objects, respective radial velocities of the one or more objects relative to a ranging sensor, and respective ranges of the one or more objects relative to the ranging sensor. Radar feature encoder 308 may operate in a similar manner as image encoder 300, but may include neural networks or other machine learning units trained specifically for extracting features from ranging sensors, such as a radar sensor.

Segmentation unit 304 may be configured to perform k-means clustering on the first image feature vectors produced by image encoder 300 to cluster the first image feature vectors into k clusters, where k is the number of the one or more objects in the ranging sensor information. That is, segmentation unit clusters the feature vectors in a frame of video data into k clusters based on the number of objects detected by a radar sensor. In this way, the number of objects detected in a video frame may be more accurate and over/under segmentation issues may be mitigated.

In general, K-means clustering is a method used to partition feature vectors into distinct groups or clusters based on their similarities. At a high level, segmentation unit 304 may k initial cluster centroids randomly from the video frame, and may assign each feature vector to the nearest centroid based on a distance metric (e.g., a Euclidean distance). Segmentation unit 304 may update the centroids as the mean of all feature vectors assigned to each cluster. Segmentation unit 304 may repeat the assignment and update steps until the centroids no longer change significantly or a maximum number of iterations is reached. The result is k clusters, each with a centroid representing the average of the feature vectors within that cluster. A more detailed frame-level segmentation example that may be performed segmentation unit 304 is detailed below.

Segmentation unit 304 may operate on a set of N feature vectors X={x₁, x₂, . . . , x_{N}} output by scene flow determination unit 302, where each xᵢ∈R^{D} is a D-dimensional feature vector. The number of clusters k is set to the number of objects n detected by radar near scan and far scan unit 306 in the current frame. The k-means clustering is configured to partition X into k clusters C={C₁, C₂, . . . , Cₖ} that minimize the within-cluster sum of squares (WCSS):

$$WCSS ( C ) = {\sum }_{\{ i = 1 \}}^{k} {\sum }_{\{ {x}_{j} ∈ {C}_{i} \}}^{2} \vert {x}_{j} - {μ}_{i} \vert$$

### Where:

i indexes the clusters from 1 to k,
xⱼ represents a feature vector belonging to cluster Cᵢ,
μᵢ is the mean (centroid) of cluster Cᵢ, and
   |⋅| denotes the L2 norm or Euclidean distance

Segmentation unit 304 minimize the metric WCSS (C), finding a clustering that brings together feature vectors that are close together while separating vectors from different clusters. For example, segmentation unit 304 may perform the following process. First segmentation unit 304 initializes the cluster centers μ₁, μ₂, . . . , μₖ. Segmentation unit 304 the assigns each point x to the nearest cluster as follows:

$${C}_{i} = \{ x \vert \vert x - {μ}_{i} \vert \leq \vert x - {μ}_{j} \vert , ∀ j \neq i \}$$

### Where:

Cᵢ represents the i-th cluster,
x is a feature vector,
μᵢ is the centroid of the i-th cluster,
μⱼ is the centroid of any other cluster j, where j≠i, and
   |⋅| denotes the L2 norm or Euclidean distance

Segmentation unit 304 then recalculates cluster centers as follows:

$${μ}_{i} = \frac{1}{\vert {C}_{i} \vert} {\sum }_{\{ x ∈ {C}_{i} \}} x$$

Segmentation unit 304 may then repeat the assignment and recalculation processes until convergence or maximum iterations reached. The above techniques partitions the scene flow features into k clusters in a way that minimizes intra-cluster distances, avoiding merging of distinct objects compared to density-based methods.

Feature association unit 310 is configured to associate feature vectors from the first image feature vectors and the ranging feature vectors that are from common objects of the one or more objects to generate associated feature vectors. That is, feature association unit 310 may be configured to find objects in the radar scan and objects in the segmented scene flow that have similar radar ranges and real-world points 330 and minimal differences between radial velocities 332. Feature association unit 310 may then associate the feature vectors produced from the ranging sensor and video data for further processing to determine more accurate 3D object velocities.

In a more specific example described below, feature association unit 310 is configured to associate the feature vectors from the first image feature vectors and the ranging feature vectors based on the respective initial 3D velocities, the respective radial velocities of the one or more objects relative to a ranging sensor, and the respective ranges of the one or more objects relative to the ranging sensor. Given a set of ‘n’ points from scene flow determination unit 302, and ‘m’ points from radar near scan and far scan unit 306, feature association unit 310 may set S={s₁, s₂, . . . , sₙ} to be the set of n scene flow points and let R={r₁, r₂, . . . , rₘ} be the set of m radar returns

Feature association unit 310 may derive the ‘n’ radial velocity from the scene flow and ‘n’ object range from the corresponding image pixels, where

$${v}_{r}^{i} = f ( {s}_{i} )$$

(Function to estimate radial velocity from scene flow point). Feature association unit 310 may also derive a predicted object range, where rᵢ=g(sᵢ) (Function to estimate range from image coordinates of sᵢ).

For a given scene flow point, feature association unit may associate the top-5 radial velocities from scene flow and radar radial velocities, similarly, to derive the top-5 associations based on object range using a distance metric. For each scene flow point sᵢ, feature association unit 310 determines radial velocity matches and range matches as described below.

Radial velocity matches:

$${M}_{v} = {r}_{j} \vert \vert {v}_{r}^{i} - {v}_{r}^{j} \vert < {θ}_{v} , 1 \leq j \leq m$$

### Where:

Mᵥ represents the set of radar matches based on radial velocity,
rⱼ is a radar return point,

$${v}_{r}^{i}$$

is the radial velocity . . . estimated for scene flow point sᵢ,

$${v}_{r}^{j}$$

is the radial velocity measured by radar return rⱼ,
   |⋅| denotes the absolute value or magnitude,
θᵥ is the threshold for the velocity difference,
1≤j≤m indicates j ranges from 1 to m, the number . . . of radar returns, and
Mᵥ contains all radar returns rⱼ where the absolute difference between its measured velocity

$${v}_{r}^{j}$$

and the scene flow point velocity

$${v}_{r}^{i}$$

is less than the threshold θᵥ.

Range matches:

$${M}_{r} = {r}_{j} \vert \vert {r}_{i} - {r}_{j} \vert < {θ}_{r} , 1 \leq j \leq m$$

### Where:

Mᵣ represents the set of radar matches based on range,
rᵢ is the predicted range . . . of the scene flow point,
rⱼ is the measured range of radar return rⱼ,
   |⋅| denotes the absolute value or magnitude of the difference between predicted and measured ranges,
θᵣ is the threshold for the allowed range difference,
1≤j≤m indicates j indexes from 1 to m radar returns, and
Mᵣ contains radar returns rⱼ where the absolute difference between its measured range rᵢ and the predicted scene flow point range rᵢ is within the threshold θᵣ.

Performing a set operation on the associated top-5 matches and identifying the closest based on both the distance will result in the final association between the given scene flow point and associated radar point. Feature association unit 310 may select the top k matches by distance:

$${M}_{v}^{topK} , {M}_{r}^{topK}$$

### Where

$${M}_{v}^{topK}$$

refers to the top K matches from the set Mᵥ of radar returns matched based on radial velocity, and

$${M}_{r}^{topK}$$

refers to the top K matches from the set Mᵣ of radar returns matched based on range. The superscript \top K indicates that only the top (best) K matches are retained from each set, based on the distance metrics

Selecting the top K matches helps to narrow down the potential associations when there may be multiple radar returns within the thresholds for a given scene flow point.

$${M}_{v}^{topK} and {M}_{r}^{topK}$$

represent the subset of top K radar matches retained after considering distance for both radial velocity and range associations.

Feature association unit 310 may determine the final associated radar point as follows:

$${r}_{j} \text{*} = {M}_{v}^{topK} ⋂ {M}_{r}^{topK}$$

### Where:

rⱼ* denotes the radar point finally associated with a given scene flow point,

$${M}_{v}^{topK}$$

is the set of top K radar matches based on radial velocity,

$${M}_{r}^{topK}$$

is the set of top K radar matches based on range, and
∩ represents the set intersection operator.

The final associated radar point rⱼ* is defined as the intersection (common elements) between the top K velocity matches and top K range matches. Taking the intersection enforces that the associated point satisfies both the velocity and range criteria, improving the likelihood of a correct association.

$$if \vert {M}_{v}^{topK} ⋂ {M}_{r}^{topK} \vert > 0 else null$$

Repeat for all i to get associations for all the scene flow clusters between S and R.

Cross-attention unit 312 may then determine respective output 3D object velocities for the one or more objects based on the associated feature vectors. In one example, cross-attention unit 312 may perform a deformable cross-attention process on the associated feature vectors using the ranging feature vectors as queries and using the first image feature vectors as keys and values.

A deformable cross-attention module is often used in neural network architectures, particularly for computer vision and natural language processing. Deformable cross-attention builds upon the standard attention mechanism, introducing flexibility and adaptability to efficiently handle large and complex data structures. Unlike conventional attention mechanisms that assume a fixed and uniform structure, deformable cross-attention allows the attention mechanism to dynamically adjust its focus, making it more robust and effective in capturing relevant features across diverse and irregular data distributions.

In the context of attention mechanisms, a query is a vector that represents the entity for which the attention mechanism is trying to find relevant information. The query can be thought of as a question or a search criterion. In a neural network, the query is typically derived from the input data or an intermediate representation of the input. For example, in a transformer model used for natural language processing, the query might represent a particular word in a sentence for which the model is trying to find related words.

The key is another vector that is used to match against the query. Keys represent the potential items that the query might be interested in. Each key is paired with a value, and the attention mechanism computes a similarity score between the query and each key. The closer the match between the query and a key, the more attention the corresponding value will receive. In practice, keys are often derived from the same source as queries, such as different words in the same sentence or different regions in an image.

The value vector represents the actual information that is retrieved and aggregated based on the attention scores. Once the attention mechanism calculates the similarity between the query and each key, it uses these scores to weight the values. The weighted sum of the values forms the output of the attention mechanism. In essence, values are the information that is being sought by the query, guided by the matching process with keys.

A deformable cross-attention module extends the traditional attention mechanism by allowing it to dynamically adjust its focus. This is particularly useful in tasks where the data distribution is uneven or where the relevant information is scattered in a non-uniform manner. For instance, in object detection within images, different regions of the image might require varying levels of attention based on their relevance to the object being detected.

In computer vision, deformable cross-attention is particularly effective in tasks such as object detection, segmentation, and image synthesis. Deformable cross attention enable models to pay closer attention to important features while ignoring irrelevant background information. For example, in an image with multiple overlapping objects, a deformable attention module can selectively focus on the boundaries and key features of each object, improving detection accuracy.

In the context of this disclosure, cross-attention unit 312 may apply deformable cross-attention on the associated image and radar features to determine 3D object velocity 340 and velocity uncertainty 342. Velocity uncertainty is a number between 0 and 1 representing the probability that the 3D object velocity is correct for a given object.

Cross-attention unit 312 may define

$${f}_{r}^{k}$$

∈R^{C} as the feature vector or the k^{th} associated radar return, used as query, and may define

$${f}_{i}^{k}$$

∈R^{W×H×C} as the feature vector of the associated image region, used as key/value. Deformable cross attention aims to aggregate information from

$${f}_{i}^{k} to {f}_{r}^{k}$$

as follows:

$${f}_{r}^{′ k} = CrossAttention ( {f}_{r}^{k} , DCN ( {f}_{i}^{k} ) )$$

### Where:

$$DCN ( {f}_{i}^{k} )$$

applies deformable convolution to

$${f}_{i}^{k} ,$$

learning offsets Δp:

$${g}^{k} = {f}_{i}^{k} ( p + Δ p )$$

The function CrossAttention computes an attention between query

$${f}_{r}^{k}$$

and deformed keys/values g^{k}:

$$α = Softmax ( {f}_{r}^{k} {{W}^{Q} ( {g}^{k} {W}^{K} )}^{T} )$$

$${f}_{r}^{′ k} = α ( {g}^{k} {W}^{V} )$$

In one example, cross-attention unit 312 may be trained to predict the 3D object velocity 340 for an object using the associated features and minimize the KL divergence:

$$\hat{Θ} = arg min \frac{1}{N} \sum {D}_{KL} ( {P}_{gt} ( {v}_{gt} ) ‖ {P}_{Θ} ( {v}_{pred} ) ) ,$$

The ground-truth velocity can be formulated as a Gaussian distribution with σ→0 and the predicted velocity and uncertainty estimation σ is modeled as a single variate Gaussian distribution P_{Θ}(v).

Cross-attention unit 312 estimates velocity uncertainty 342 for each 3D object velocity 340 based on combination of radar and camera features. The uncertainty is predicted by a fully connected layer that takes the fused feature

$${f}_{r}^{′ k}$$

as the input. Uncertainty is temporally propagated based on prediction from previous frame to get more refined estimates.

In some examples, 3D object velocity 340 and velocity uncertainty 342 may be sent direct to ADAS 205 for use in making various autonomous driving decisions. In other examples, temporal consistency check unit 314 may further process 3D object velocity 340 to ensure temporal constituency and to mitigate potential negative effects of objects being occluded or partially occluded in a frame of the video data.

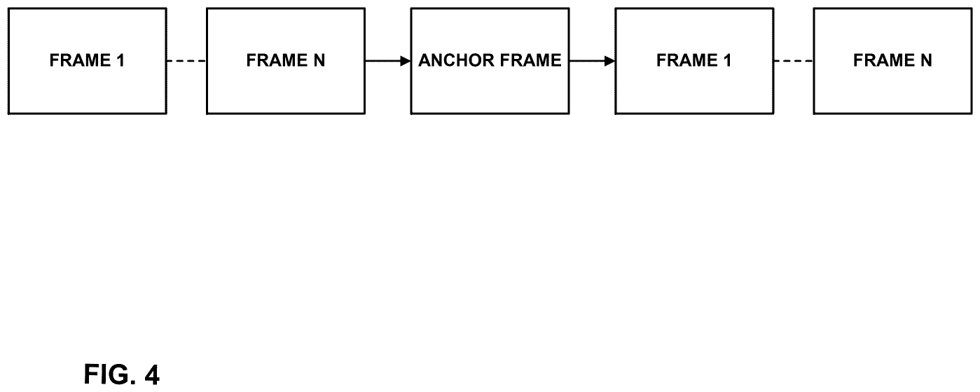

Temporal consistency check unit 314 may operate on ‘t’ frames and may initialize anchor frames A={a1, a2, . . . at} to avoid temporal propagation error. As shown in FIG. 4, the ‘t’ frames may include frame 1 through frame N, followed by an anchor frame. Any moving averages used by temporal consistency check unit 314 are reinitialized at the anchor frame. Then another ‘t’ frames (frame 1 through frame N) are processed, followed by another anchor frame, and so on. After a number of frames in each set of ‘t’ frames, temporal consistency check may calculate a moving average for the 3D object velocity of each of the objects being tracked. This moving average may be used to correct any erroneous 3D object velocity predictions, determine if an object has left the scene, and/or reinitialize a moving average for a particular object.

As discussed above, the radar object list may include object ids as well as corresponding tracking age. Temporal consistency check unit 314 may associate a radar object id to a particular predicted 3D object velocity 340 based on the range and radial velocity associated with that predicted 3D object velocity. This association allows temporal consistency check unit 314 to track a particular object across fames.

For a given object over t frames, temporal consistency check unit 314 calculates the absolute difference between the current velocity and the previous frame's weighted moving average velocity based on both the predicted 3D object velocity 340 and the velocity uncertainty 342, and if the difference is greater than a threshold, update the 3D object velocity (output velocity 344). If more than k frames deviate from the moving average calculation, temporal consistency check unit 314 may flag the object and reinitialize the velocity calculation.

Due to the radar object list-based tracking, an object that has been occluded or out of frame will not be included in the motion correction. Based on the tracking, if the object's speed has been corrected for more than ‘m’ number of frames, temporal consistency check unit may be configured to use a temporally corrected velocity. If not, the frame-level velocity (i.e., 3D object velocity 340) will be used.

Temporal consistency check unit 314 may be configured to perform the following process. Temporal consistency check unit 314 may define t as the number of frames to check consistency and initialize anchor frames A={a1, a2, . . . at}.

For each radar object ‘o’ with ID i, temporal consistency check unit 314 tracks object ‘o’ o across frames using radar object list. For frame k=1 to t:
vₖ=Corrected 3D velocity from frame-level estimation (3D object velocity 340), and
vₘₐ=Weighted moving average of velocities from prior frames:

$${v}_{m a} = \frac{1}{min ( k , t )} * {\sum }_{j = 1}^{min ( k , t )} {v}_{j} * {c}_{j}$$

Temporal consistency check unit 314 then computers an error as:

$$Error = \vert {v}_{k} - {v}_{m a} \vert$$

Temporal consistency check unit 314 then determines if the error is greater than a threshold:

$$If Error > threshold$$

If yes, temporal consistency check updates the 3D object velocity 340 with a moving average computed from previous frames:

$$δ : Update {v}_{k} = {v}_{m a}$$

Temporal consistency check unit 314 may determine if the error for a particular object is larger than a threshold may flag the 3D object for that velocity as inconsistent.

$$If {\sum }_{l = k - m}^{k} {Error}_{l} > k * δ : Flag o as inconsistent$$

Temporal consistency check unit 314 may reinitialize the 3D velocity for a particular object if the object has been flagged as being inconsistent for a threshold number of frames.

$$If o flagged for > n frames : Reinitialize 3 D velocity o$$

$$If o not present or tracked for > m frames : Use temporally corrected 3 D velocity {v}_{tc}$$

$$Else : Use frame - level 3 D velocity {v}_{k} ,$$

where v_{tc} is an updated value of vₘₐ.

In summary, temporal consistency check unit 314 may determine, for a number of frames of the video data, a moving average of a 3D object velocity for an object of the one or more objects, determine a difference between a current 3D object velocity for the object and the moving average of the 3D object velocity for the object, and replace the current 3D object velocity for the object with the moving average of the 3D object velocity for the object based on the difference being greater than a threshold.

Temporal consistency check unit 314 may be further configured to reset the moving average of the 3D object velocity for the object based on the difference between the current 3D object velocity for the object and the moving average of the 3D object velocity for the object being greater than the threshold for a predetermined number of comparisons. In addition, temporal consistency check unit 314 may determine, for a number of frames of the video data, the moving average of the 3D object velocity for the object based on the current 3D object velocity for the object, the velocity uncertainty, and a previous moving average for the 3D object velocity for the object.

As described above, the proposed techniques may be applied to both frame-level and multi-frame velocity correction. Unlike previous radar-camera associations that only uses the radar azimuth and range to project the radar points onto camera images, the techniques of this disclosure uses radial velocity and the image-based scene flow velocity. Therefore, the associated radar and camera features are spatially aware, and the outliers are effectively removed using the velocity

The techniques of this disclosure may also utilize a ranging sensor object list which includes processed points to induce temporal consistency in the predicted velocity across frames. The techniques of this disclosure may also improve error in velocity prediction caused due to a single modality and trains the network to correct the final prediction. In addition, the techniques of this disclosure may use an uncertainty estimation to temporally correct 3D velocity predictions and refine the final velocity estimation.

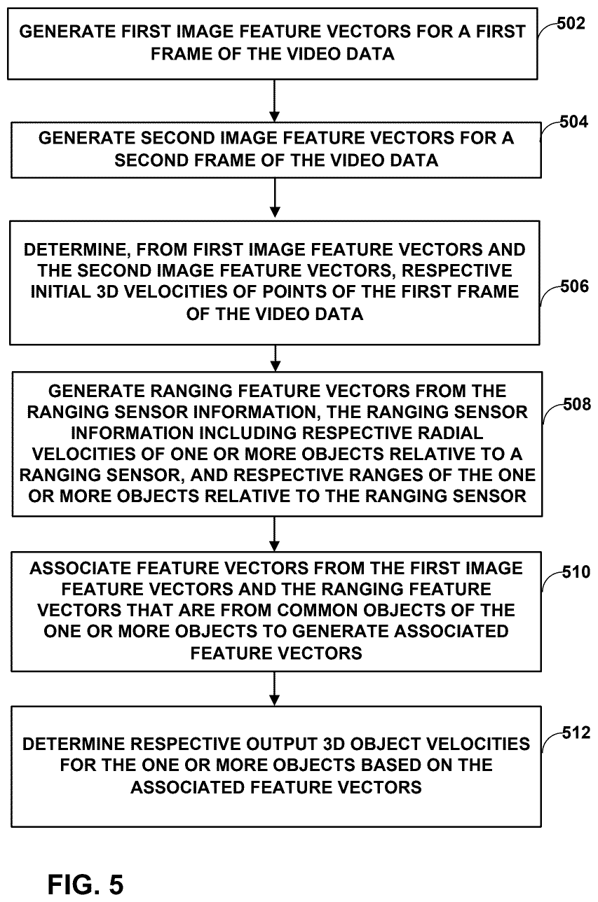

FIG. 5 is a flowchart illustrating an example method for 3D velocity determination in accordance with the techniques of this disclosure. The techniques of FIG. 5 may be performed by one or more processors or other units of computing system 200.

In one example of the disclosure, computing system 200 may be configured to generate first image feature vectors for a first frame of the video data (502), and generate second image feature vectors for a second frame of the video data (504). Computing system 200 may be further configured to determine, from first image feature vectors and the second image feature vectors, respective initial 3D velocities of points of the first frame of the video data (506). In one example, to determine, from the first image feature vectors and the second image feature vectors, the respective initial 3D velocities of the points of the first frame of the video data, computing system 200 is configured to perform one or more of optical flow estimation or scene flow estimation on the first image feature vectors and the second image feature vectors to determine the initial 3D velocities of the points of the first frame of the video data.

Computing system 200 may be further configured to generate ranging feature vectors from the ranging sensor information, the ranging sensor information including respective radial velocities of one or more objects relative to a ranging sensor, and respective ranges of the one or more objects relative to the ranging sensor (508). In some examples, computing system 200 may perform k-means clustering on the first image feature vectors to cluster the first image feature vectors into k clusters, where k is the number of the one or more objects in the ranging sensor information.

Computing system 200 may be further configured associate feature vectors from the first image feature vectors and the ranging feature vectors that are from common objects of the one or more objects to generate associated feature vectors (510). In one example, computing system 200 may associate the feature vectors from the first image feature vectors and the ranging feature vectors based on the respective initial 3D velocities, the respective radial velocities of one or more objects relative to a ranging sensor, and the respective ranges of the one or more objects relative to the ranging sensor.

Computing system 200 may be further configured to determine respective output 3D object velocities for the one or more objects based on the associated feature vectors (512). In one example, computing system 200 may perform a deformable cross-attention process on the associated feature vectors using the ranging feature vectors as queries and using the first image feature vectors as keys and values.

In a further example of the disclosure, computing system 200 may determine, for a number of frames of the video data, a moving average of a 3D object velocity for an object of the one or more objects, determine a difference between a current 3D object velocity for the object and the moving average of the 3D object velocity for the object, and replace the current 3D object velocity for the object with the moving average of the 3D object velocity for the object based on the difference being greater than a threshold.

In another example of the disclosure, computing system 200 may reset the moving average of the 3D object velocity for the object based on the difference between the current 3D object velocity for the object and the moving average of the 3D object velocity for the object being greater than the threshold for a predetermined number of comparisons.

In still another example of the disclosure, computing system 200 may determine a velocity uncertainty for the current 3D object velocity for the object, and determine, for a number of frames of the video data, the moving average of the 3D object velocity for the object based on the current 3D object velocity for the object, the velocity uncertainty, and a previous moving average for the 3D object velocity for the object.

In another example of the disclosure, computing system 200 may determine a respective velocity uncertainty for each of the respective output 3D object velocities, and determine one or more autonomous driving operations based on at least one respective 3D object velocity and at least one respective velocity uncertainty.

The following numbered clauses illustrate one or more aspects of the devices and techniques described in this disclosure.

Clause 1. An apparatus configured to determine a velocity of one or more objects, the apparatus comprising: a memory configured to store video data and ranging sensor information; and processing circuitry connected to the memory, the processing circuitry configured to: generate first image feature vectors for a first frame of the video data; generate second image feature vectors for a second frame of the video data; determine, from first image feature vectors and the second image feature vectors, respective initial 3D velocities of points of the first frame of the video data; generate ranging feature vectors from the ranging sensor information, the ranging sensor information including respective radial velocities of one or more objects relative to a ranging sensor, and respective ranges of the one or more objects relative to the ranging sensor; associate feature vectors from the first image feature vectors and the ranging feature vectors that are from common objects of the one or more objects to generate associated feature vectors; and determine respective output 3D object velocities for the one or more objects based on the associated feature vectors.

Clause 2. The apparatus of Clause 1, wherein to determine, from the first image feature vectors and the second image feature vectors, the respective initial 3D velocities of the points of the first frame of the video data, the processing circuitry is configured to: perform one or more of optical flow estimation or scene flow estimation on the first image feature vectors and the second image feature vectors to determine the initial 3D velocities of the points of the first frame of the video data.

Clause 3. The apparatus of any of Clauses 1-2, wherein the processing circuitry is further configured to: perform k-means clustering on the first image feature vectors to cluster the first image feature vectors into k clusters, where k is a number of the one or more objects in the ranging sensor information.

Clause 4. The apparatus of any of Clauses 1-3, wherein to associate the feature vectors from the first image feature vectors and the ranging feature vectors that are from common objects of the one or more objects to generate the associated feature vectors, the processing circuitry is configured to: associate the feature vectors from the first image feature vectors and the ranging feature vectors based on the respective initial 3D velocities, respective radial velocities of the one or more objects relative to the ranging sensor, and the respective ranges of the one or more objects relative to the ranging sensor.

Clause 5. The apparatus of any of Clauses 1-4, wherein to determine the respective output 3D object velocities for the one or more objects based on the associated feature vectors, the processing circuitry is configured to: perform a deformable cross-attention process on the associated feature vectors using the ranging feature vectors as queries and using the first image feature vectors as keys and values.

Clause 6. The apparatus of any of Clauses 1-5, wherein the processing circuitry is further configured to: determine, for a number of frames of the video data, a moving average of a 3D object velocity for an object of the one or more objects; determine a difference between a current 3D object velocity for the object and the moving average of the 3D object velocity for the object; and replace the current 3D object velocity for the object with the moving average of the 3D object velocity for the object based on the difference being greater than a threshold.

Clause 7. The apparatus of Clause 6, wherein the processing circuitry is further configured to: reset the moving average of the 3D object velocity for the object based on the difference between the current 3D object velocity for the object and the moving average of the 3D object velocity for the object being greater than the threshold for a predetermined number of comparisons.

Clause 8. The apparatus of Clause 6, wherein the processing circuitry is further configured to: determine a velocity uncertainty for the current 3D object velocity for the object; and determine, for a number of frames of the video data, the moving average of the 3D object velocity for the object based on the current 3D object velocity for the object, the velocity uncertainty, and a previous moving average for the 3D object velocity for the object.

Clause 9. The apparatus of any of Clauses 1-8, wherein the processing circuitry is further configured to: determine a respective velocity uncertainty for each of the respective output 3D object velocities; and determine one or more autonomous driving operations based on at least one respective 3D object velocity and at least one respective velocity uncertainty.

Clause 10. The apparatus of any of Clauses 1-9, wherein the apparatus is part of a vehicle and the processing circuitry is further configured to: determine one or more autonomous driving operations based on at least one respective 3D object velocity.

Clause 11. A method for determining a velocity of one or more objects, the method comprising: generating first image feature vectors for a first frame of the video data; generating second image feature vectors for a second frame of the video data; determining, from first image feature vectors and the second image feature vectors, respective initial 3D velocities of points of the first frame of the video data; generating ranging feature vectors from the ranging sensor information, the ranging sensor information including respective radial velocities of one or more objects relative to a ranging sensor, and respective ranges of the one or more objects relative to the ranging sensor; associating feature vectors from the first image feature vectors and the ranging feature vectors that are from common objects of the one or more objects to generate associated feature vectors; and determining respective output 3D object velocities for the one or more objects based on the associated feature vectors.

Clause 12. The method of Clause 11, wherein determining, from the first image feature vectors and the second image feature vectors, the respective initial 3D velocities of the points of the first frame of the video data comprises: performing one or more of optical flow estimation or scene flow estimation on the first image feature vectors and the second image feature vectors to determine the initial 3D velocities of the points of the first frame of the video data.

Clause 13. The method of any of Clauses 11-12, further comprising: performing k-means clustering on the first image feature vectors to cluster the first image feature vectors into k clusters, where k is a number of the one or more objects in the ranging sensor information.

Clause 14. The method of any of Clauses 11-13, wherein associating the feature vectors from the first image feature vectors and the ranging feature vectors that are from common objects of the one or more objects to generate the associated feature vectors comprises: associating the feature vectors from the first image feature vectors and the ranging feature vectors based on the respective initial 3D velocities, the respective radial velocities of the one or more objects relative to the ranging sensor, and the respective ranges of the one or more objects relative to the ranging sensor.

Clause 15. The method of any of Clauses 11-14, wherein determining the respective output 3D object velocities for the one or more objects based on the associated feature vectors comprises: performing a deformable cross-attention process on the associated feature vectors using the ranging feature vectors as queries and using the first image feature vectors as keys and values.

Clause 16. The method of any of Clauses 11-15, further comprising: determining, for a number of frames of the video data, a moving average of a 3D object velocity for an object of the one or more objects; determining a difference between a current 3D object velocity for the object and the moving average of the 3D object velocity for the object; and replacing the current 3D object velocity for the object with the moving average of the 3D object velocity for the object based on the difference being greater than a threshold.

Clause 17. The method of Clause 16, further comprising: resetting the moving average of the 3D object velocity for the object based on the difference between the current 3D object velocity for the object and the moving average of the 3D object velocity for the object being greater than the threshold for a predetermined number of comparisons.

Clause 18. The method of Clause 16, further comprising: determining a velocity uncertainty for the current 3D object velocity for the object; and determining, for a number of frames of the video data, the moving average of the 3D object velocity for the object based on the current 3D object velocity for the object, the velocity uncertainty, and a previous moving average for the 3D object velocity for the object.

Clause 19. The method of any of Clauses 11-18, further comprising: determining a respective velocity uncertainty for each of the respective output 3D object velocities; and determining one or more autonomous driving operations based on at least one respective 3D object velocity and at least one respective velocity uncertainty.

Clause 20. A non-transitory computer-readable storage medium storing instructions that, when executed, cause one or more processors to: generate first image feature vectors for a first frame of the video data; generate second image feature vectors for a second frame of the video data; determine, from first image feature vectors and the second image feature vectors, respective initial 3D velocities of points of the first frame of the video data; generate ranging feature vectors from the ranging sensor information, the ranging sensor information including respective radial velocities of the one or more objects, and respective ranges of the one or more objects relative to the ranging sensor; associate feature vectors from the first image feature vectors and the ranging feature vectors that are from common objects of the one or more objects to generate associated feature vectors; and determine respective output 3D object velocities for the one or more objects based on the associated feature vectors.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. An apparatus configured to determine a velocity of one or more objects, the apparatus comprising:
a memory configured to store video data and ranging sensor information; and
processing circuitry connected to the memory, the processing circuitry configured to:
generate first image feature vectors for a first frame of the video data;
generate second image feature vectors for a second frame of the video data;
determine, from first image feature vectors and the second image feature vectors, respective initial 3D velocities of points of the first frame of the video data;
generate ranging feature vectors from the ranging sensor information, the ranging sensor information including respective radial velocities of one or more objects relative to a ranging sensor, and respective ranges of the one or more objects relative to the ranging sensor;
associate feature vectors from the first image feature vectors and the ranging feature vectors that are from common objects of the one or more objects to generate associated feature vectors; and
determine respective output 3D object velocities for the one or more objects based on the associated feature vectors.

2. The apparatus of claim 1, wherein to determine, from the first image feature vectors and the second image feature vectors, the respective initial 3D velocities of the points of the first frame of the video data, the processing circuitry is configured to:
perform one or more of optical flow estimation or scene flow estimation on the first image feature vectors and the second image feature vectors to determine the initial 3D velocities of the points of the first frame of the video data.

3. The apparatus of claim 1, wherein the processing circuitry is further configured to:
perform k-means clustering on the first image feature vectors to cluster the first image feature vectors into k clusters, where k is a number of the one or more objects in the ranging sensor information.

4. The apparatus of claim 1, wherein to associate the feature vectors from the first image feature vectors and the ranging feature vectors that are from common objects of the one or more objects to generate the associated feature vectors, the processing circuitry is configured to:
associate the feature vectors from the first image feature vectors and the ranging feature vectors based on the respective initial 3D velocities, the respective radial velocities of the one or more objects relative to the ranging sensor, and the respective ranges of the one or more objects relative to the ranging sensor.

5. The apparatus of claim 1, wherein to determine the respective output 3D object velocities for the one or more objects based on the associated feature vectors, the processing circuitry is configured to:
perform a deformable cross-attention process on the associated feature vectors using the ranging feature vectors as queries and using the first image feature vectors as keys and values.

6. The apparatus of claim 1, wherein the processing circuitry is further configured to:
determine, for a number of frames of the video data, a moving average of a 3D object velocity for an object of the one or more objects;
determine a difference between a current 3D object velocity for the object and the moving average of the 3D object velocity for the object; and
replace the current 3D object velocity for the object with the moving average of the 3D object velocity for the object based on the difference being greater than a threshold.

7. The apparatus of claim 6, wherein the processing circuitry is further configured to:
reset the moving average of the 3D object velocity for the object based on the difference between the current 3D object velocity for the object and the moving average of the 3D object velocity for the object being greater than the threshold for a predetermined number of comparisons.

8. The apparatus of claim 6, wherein the processing circuitry is further configured to:
determine a velocity uncertainty for the current 3D object velocity for the object; and
determine, for a number of frames of the video data, the moving average of the 3D object velocity for the object based on the current 3D object velocity for the object, the velocity uncertainty, and a previous moving average for the 3D object velocity for the object.

9. The apparatus of claim 1, wherein the processing circuitry is further configured to:
determine a respective velocity uncertainty for each of the respective output 3D object velocities; and
determine one or more autonomous driving operations based on at least one respective 3D object velocity and at least one respective velocity uncertainty.

10. The apparatus of claim 1, wherein the apparatus is part of a vehicle and the processing circuitry is further configured to:
determine one or more autonomous driving operations based on at least one respective 3D object velocity.

11. A method for determining a velocity of one or more objects, the method comprising:
generating first image feature vectors for a first frame of video data;
generating second image feature vectors for a second frame of the video data;
determining, from first image feature vectors and the second image feature vectors, respective initial 3D velocities of points of the first frame of the video data;
generating ranging feature vectors from ranging sensor information, the ranging sensor information including respective radial velocities of one or more objects relative to a ranging sensor, and respective ranges of the one or more objects relative to the ranging sensor;
associating feature vectors from the first image feature vectors and the ranging feature vectors that are from common objects of the one or more objects to generate associated feature vectors; and
determining respective output 3D object velocities for the one or more objects based on the associated feature vectors.

12. The method of claim 11, wherein determining, from the first image feature vectors and the second image feature vectors, the respective initial 3D velocities of the points of the first frame of the video data comprises:
performing one or more of optical flow estimation or scene flow estimation on the first image feature vectors and the second image feature vectors to determine the initial 3D velocities of the points of the first frame of the video data.

13. The method of claim 11, further comprising:
performing k-means clustering on the first image feature vectors to cluster the first image feature vectors into k clusters, where k is a number of the one or more objects in the ranging sensor information.

14. The method of claim 11, wherein associating the feature vectors from the first image feature vectors and the ranging feature vectors that are from common objects of the one or more objects to generate the associated feature vectors comprises:
associating the feature vectors from the first image feature vectors and the ranging feature vectors based on the respective initial 3D velocities, the respective radial velocities of the one or more objects relative to the ranging sensor, and the respective ranges of the one or more objects relative to the ranging sensor.

15. The method of claim 11, wherein determining the respective output 3D object velocities for the one or more objects based on the associated feature vectors comprises:
performing a deformable cross-attention process on the associated feature vectors using the ranging feature vectors as queries and using the first image feature vectors as keys and values.

16. The method of claim 11, further comprising:
determining, for a number of frames of the video data, a moving average of a 3D object velocity for an object of the one or more objects;
determining a difference between a current 3D object velocity for the object and the moving average of the 3D object velocity for the object; and
replacing the current 3D object velocity for the object with the moving average of the 3D object velocity for the object based on the difference being greater than a threshold.

17. The method of claim 16, further comprising:
resetting the moving average of the 3D object velocity for the object based on the difference between the current 3D object velocity for the object and the moving average of the 3D object velocity for the object being greater than the threshold for a predetermined number of comparisons.

18. The method of claim 16, further comprising:
determining a velocity uncertainty for the current 3D object velocity for the object; and
determining, for a number of frames of the video data, the moving average of the 3D object velocity for the object based on the current 3D object velocity for the object, the velocity uncertainty, and a previous moving average for the 3D object velocity for the object.

19. The method of claim 11, further comprising:
determining a respective velocity uncertainty for each of the respective output 3D object velocities; and
determining one or more autonomous driving operations based on at least one respective 3D object velocity and at least one respective velocity uncertainty.

20. A non-transitory computer-readable storage medium storing instructions that, when executed, cause one or more processors to:
generate first image feature vectors for a first frame of video data;
generate second image feature vectors for a second frame of the video data;
determine, from first image feature vectors and the second image feature vectors, respective initial 3D velocities of points of the first frame of the video data;
generate ranging feature vectors from ranging sensor information, the ranging sensor information including respective radial velocities of one or more objects relative to a ranging sensor, and respective ranges of the one or more objects relative to the ranging sensor;
associate feature vectors from the first image feature vectors and the ranging feature vectors that are from common objects of the one or more objects to generate associated feature vectors; and
determine respective output 3D object velocities for the one or more objects based on the associated feature vectors.
